(19) United States
(12) Patent Application Publication
(10) Pub. No.: US 2016/0063054 A1
(43) Pub. Date: Mar. 3, 2016

(54) METHOD AND SYSTEM FOR CROWD SOURCED CONTACT DATABASE MANAGEMENT

(71) Applicant: Scott THOMPSON, Hatfield, PA (US)

(72) Inventor: Scott THOMPSON, Hatfield, PA (US)

(21) Appl. No.: 14/835,135

(22) Filed: Aug. 25, 2015

Related U.S. Application Data
(60) Provisional application No. 62/041,810, filed on Aug. 26, 2014.

(51) Int. Cl. G06F 17/30; G06Q 30/02; G06Q 50/00; H04L 29/06

(52) U.S. Cl. CPC G06F 17/30377; G06F 17/30368; G06F 17/30339; G06F 17/30575; G06F 17/30362; H04L 65/403; H04L 65/1069; G06Q 30/0203; G06Q 30/0217; G06F 17/30879; G06Q 50/01

(57) ABSTRACT

A system and method for managing a contact information database is disclosed. The system includes accessing, uploading, and storing a contact data list stored on a user device to the contact information database, sending an invitation to other user devices to connect to the contact information database, uploading and storing the respective contact data list stored on each of the user devices in the contact information database, automatically updating the first user device with contact information corresponding to the subset of the user devices, monitoring contact information corresponding to user devices connected to the contact information database, sending a verification message to at least one of user devices when the corresponding contact record is changed, updating the corresponding contact record upon receiving verification, and automatically updating the respective contact data lists stored on each of the connected user devices with the changed contact data entry.

### RELATED APPLICATIONS

The present application claims the benefit of U.S. Provisional Application No. 62/041,810 entitled “Method and System for Crowd Sourced Contact Database Management” filed on Aug. 26, 2014.

### FIELD

The present disclosure relates to technology facilitating the management of a database, specifically a database storing contact information for a plurality of user devices and merchant devices.

### BACKGROUND

Conventionally, people have maintained contact lists on paper or by manually storing the contact information on an electronic device such as a mobile phone or a personal digital assistant (PDA). However, the information is often outdated. This places a large burden on users to maintain and/or update contact information of all their contacts. Therefore, whenever someone's email address, phone numbers, or any other piece of contact information is changed, they must provide their contacts with the most current contact data. This may involve sending updated information by email, text, or by telephoning contacts in an address book and making others aware that some information has changed and they need to manually update their contact list, which is time consuming, depends on the action of others, requires multiple computer operations, and inefficient multiple electronic communications.

Known systems offering automated updating of electronic contact information and ensuring most current contact information provide a method for each user to update their own address book entry, which is then automatically transmitted to all the other user contacts linked to their address book. Although these services do automate the cumbersome process of updating contact information, it does require that all the contacts sign up for the service. However, contact information for people who have not subscribed to the above service is not updated. Therefore, the contact information for these members must be manually entered and updated. Thus, for a large number of contacts, it is still necessary to send updated information by email, text, or by telephoning to contacts in an address book and making others aware that some information has changed and they need to manually update their contact list, which is time consuming, depends on the action of others, requires multiple computer operations, and inefficient multiple electronic communications.

Known systems also do not offer a tickler or reminder system based on monitoring all linked databases for real-time changes within the network. If a first user contacts a second user outside of the linked system (using a phone call, email, or face-to-face communication) and that second user updates the first user's contact data in the second user's device, then that change is only found in the second user's device and no process is employed to update the rest of the first user's contacts. Known systems also do not allow for contact data to be moved from a first platform and programming language, to populate a second contact database operating on a second platform and programming language, without the use of programming language translation software, by matching contact data, contact by contact, through non-programming language specific data, such as a phone number, to compile a matched contact list in a second programming language and platform, to be used to populate a second contact database of a different programming language and platform, and this same process can be used to translate contact data across spoken and/or written languages as well.

In addition, in an instance where the user wishes to avoid being contacted by an entity that has the user's contact information, it requires the user to change their contact information. This places a significant burden on the user as it may become necessary for the user to obtain a new phone number, facsimile number, and/or e-mail address. The user is then required to provide their new contact information to their contacts.

Therefore, there is a need to develop technical solutions for improved management of a database storing contact information that reduces the need for human input of information, reduces electronic communications and updating, eliminates the need to translate contact data from platform to platform and programming language to programming language, eliminates the need to translate contact data across written and spoken languages, and reconciles multiple databases in a computationally less intense manner.

### SUMMARY

The present disclosure provides a description of a system and method for crowd sourced contact database management that provides a technical solution not found in the prior art.

### Cloud Based System

A method for managing a contact information database of a first user device is disclosed. The method includes a contact information database and a processing server. The contact information database includes either a single or a plurality of contact records corresponding to a single or a plurality of users. The method includes accessing a contact data list stored on a first user device, the contact data list including either a single or a plurality of contact data entries corresponding to either a single or a plurality of user devices, uploading the contact data list stored on the first user device to a centralized contact information database, storing each of the contact data entries of the contact data list stored on the first user device in a respective contact record of the contact information database, posting an advertised link and/or machine readable code, or sending an invitation to each of single or the plurality of user devices to connect to the contact information database, allowing the users of the devices to enter their most current contact data, the plurality of user devices each including a respective contact data list, uploading and storing the current contact data of each user as well as their respective contact data list stored on each of the plurality of user devices in the respective contact records of the central contact information database upon receiving an invitation acceptance notice from a subset of the plurality of user devices, automatically updating the plurality of contact data entries stored in the contact data list of the first user device with updated contact data of each joined user as well as contact information corresponding to the subset of the plurality of user devices connected to the central contact information database, allowing each user to select the type of contact data to share with individual members of their contact databases, monitoring contact information corresponding to each of the subset of the plurality of user devices connected to the contact information database, sending a request for update message to at least one of the plurality of user devices when the contact record corresponding to the at least one user device stored in the contact information database is changed, updating the contact record corresponding to the at least one user device stored in the contact information database upon receiving a request for update from the at least one user device, automatically updating the contact data entry corresponding to the at least one user device stored in the contact data list of the first user device with updated contact information corresponding to the at least one user device, and automatically updating the respective contact data list stored on each of the subset of the plurality of user devices connected to the contact information database with the changed contact data entry corresponding to at least one user device, allowing changes and updates to be made to contact data and contact databases in real time

### Smartphone or Platform Based System

In another embodiment, the method includes a contact information database and a processing server. The contact information database includes either a single or a plurality of contact records corresponding to each of a single or a plurality of users. The method includes accessing a contact data list stored on a first user device, the contact data list including either a single or a plurality of contact data entries corresponding to a single or a plurality of user devices, posting an advertised link, scan-able code, or sending an invitation to each of the single or plurality of user devices found in the contact database to link together, allowing the users of the devices to enter their most current contact data that is shared upon linking, providing a system that allows each user to make changes to their own contact data within their own device, to instantly update all connected users in real-time, automatically updating the plurality of contact data entries stored in the contact data list of the first user device with updated contact data of each joined user, allowing each user to select the type of contact data (examples: business, social, all, etc.) to share with individual members of their contact database, monitoring contact information corresponding to each of the subset of the plurality of user devices connected to the contact information database, sending a Request for Update message to at least one of the plurality of user devices when the contact record corresponding to the at least one user device stored in the contact information database is changed, updating the contact record corresponding to the at least one user device stored in the contact information database upon receiving Request for Update from the at least one user device, automatically updating the contact data entry corresponding to the at least one user device stored in the contact data list of the first user device with updated contact information corresponding to the at least one user device, and automatically updating the respective contact data list stored on each of the subset of the plurality of user devices connected to the contact information database with the changed contact data entry corresponding to at least one user device, allowing changes and updates to be made to contact data and contact databases in real time.

System Enabling Movement of Data Between Platforms without Translation

In another embodiment, a system for exchanging the contact data found in a first device's database of one programming language and platform to a second programming language and platform is disclosed. The system comprises a plurality of contact information databases with at least two devices with databases where each device may have the same programming language and platform or the same programming language and platform, and a processor. The contact information database includes a plurality of contact records corresponding to each of the plurality of users. The processing device is configured to access a contact data list stored on a first user device, the contact data list including a plurality of contact data entries corresponding to a plurality of user devices, either acting directly from device to device or upload the contact data list stored on the first user device to the centralized contact information database, store each of the contact data entries of the contact data list stored on the first user device in a respective contact record of the centralized contact information database, search all connected databases system-wide for contact data stored in a second platform language that matches data stored in the first programming language and platform, compile a new databases in the second programming language and platform, then send this data to a second device that operates on the second programming language and platform, to populate the contact database of the second device. This same system can be used to translate entire contact databases from one written or spoken language to a second by searching for contact data of each specific user that is saved in the second language, then compiling that list into a new database.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture and data flow diagram illustrating a method and system for managing contact information of a plurality of users in accordance with exemplary embodiments.

FIG. 2 is a high level architecture and data flow diagram illustrating a system for managing contact information of a plurality of users in accordance with exemplary embodiments.

FIG. 3 is a high level architecture and data flow diagram illustrating a system for translating contact data across mobile software platforms in accordance with exemplary embodiments.

FIG. 4 is a high level architecture and data flow diagram illustrating a system for managing contact information of a plurality of users in accordance with exemplary embodiments.

FIG. 5 is block diagram illustrating the contact information database of FIG. 1 in accordance with exemplary embodiments.

FIGS. 6A and 6B show a flowchart illustrating the method and system for managing contact information of a plurality of users in accordance with exemplary embodiments.

FIG. 7 is a block diagram illustrating computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

User Device—A user device may be any type of computing device suitable for performing the functions as disclosed herein, such as a cellular phone, smart phone, tablet computer, personal digital assistant (PDA), wearable electronics, desktop computer, service database, hosted platform, or the like.

Merchant—An entity that provides products (e.g., goods and/or services) for purchase by another entity, such as a consumer or another merchant. A merchant may be a consumer, a retailer, a wholesaler, a manufacturer, individual user, or any other type of entity that may provide products for purchase as will be apparent to persons having skill in the relevant art. In some instances, a merchant may have special knowledge in the products provided for purchase. In other instances, a merchant may not have or require any special knowledge in offered products. In some embodiments, an entity involved in a single transaction may be considered a merchant, and may be someone otherwise not in a related business, such as a purchaser in a person to person exchange.

Merchant Device—A merchant device may be any type of computing device suitable for performing the functions as disclosed herein, such as a cellular phone, smartphone, tablet computer, PDA, wearable device, bodily-inserted electronics, desktop computer, business platform, or the like.

### Method and System for Contact Database Management Description

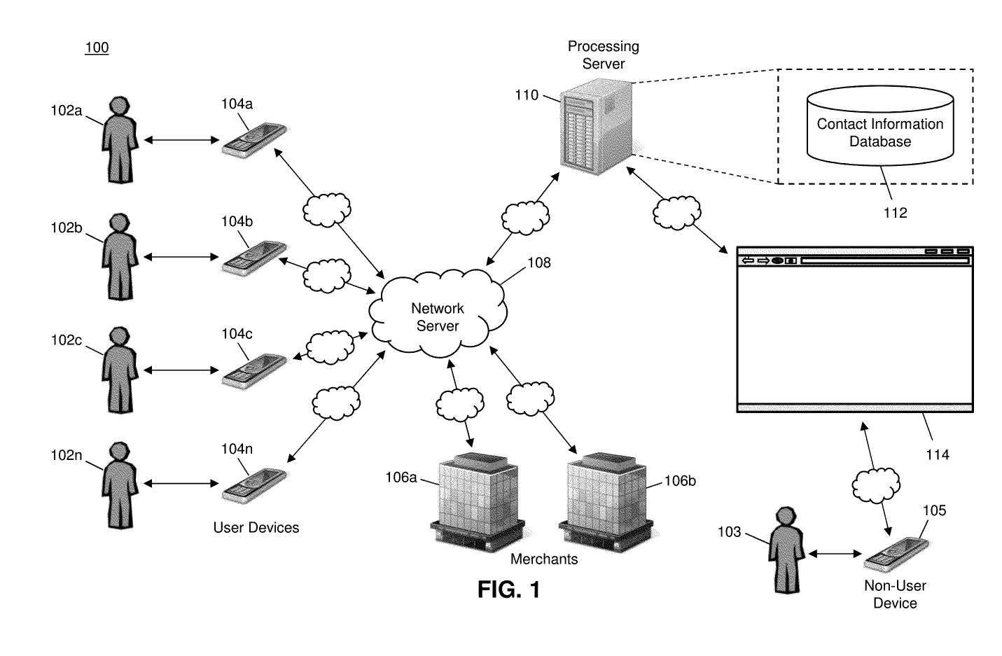

FIG. 1 shows a high level architecture and data flow diagram illustrating a method and system for managing contact information of a plurality of users in accordance with exemplary embodiments.

The system 100 includes a plurality of user devices 104 (104a, 104b, 104c . . . 104n). The plurality of user devices 104 are each associated with one of a plurality of users 102 (102a, 102b, 102c . . . 102n). As described above, the plurality of user devices may be any type of computing device suitable for performing the functions as disclosed herein, such as a cellular phone, smart phone, tablet computer, PDA, wearable electronics, bodily-inserted electronics, desktop computer, business platform, or the like. Moreover, each user may be associated with more than one user device. For instance, a user 102 may access the system using one or more of a cellular phone, smart phone, tablet computer, PDA, wearable electronics, desktop computer, or the like. This situation is becoming increasingly common as users use both their personal device and a device for the purposes of their employment. It should be understood that the user 102 need not be an individual. The user 102 may be a group of individuals, a corporation, or a group of corporations. The following description for the method and system for managing contact information for a plurality of users should therefore not be construed to only encompass individual users.

The system 100 for managing the contact information database includes the user entering their most current contact data grouped and labeled to be “Personal,” and/or “Business,” and/or “All,” and/or “None,” that is shared with all users linked with the user, the user choosing what kind of data to share with each contact in their database, the user updating all connected users by simply changing the user's own personal data in their device, accessing a contact data list of a first user 102a in a first device 104a when the user device 104a connects to the system 100. The contact data list of the first user device 104a includes a plurality of contact data entries. Each of the contact data entries corresponds to the contact information of a plurality of users 102 and non-users 103. Non-users 103 are defined as entities that are not connected to the processing server 110 via the network server 108. Non-users 103 may include people or businesses who do not wish to provide access to their respective user devices 105 and the contact data list stored on their respective user devices 105. Moreover, when a second user is added to the contact data list of the first user device 104a, the contact data list of the first user device 104a is accessed by the processing server 110 via the network server 108.

In another embodiment, the system allows each user to invite one, all, or a subsection of their database to join the system.

In one embodiment of the system, existing account data may be uploaded from a first device to a centralized contact database, where that account data is stored account by account, then downloaded into a second device where it populates that device's default contact database. Contact data may be translated in the process to a second programming language, to be downloaded into a different kind of device. An example is the contact data is uploaded from an iOS device and then downloaded to an Android device. This system might also start with iOS contact data that has been uploaded to the centralized contact database. Instead of translating that contact data to a second programming language and platform, the system may search the entire network for users that have each individual contact of that database stored in the language of the second device, compile all the matched contacts in the second programming language and platform, then download that compiled list to populate the second device that is operating with the second programming language and platform.

In order to facilitate the exchange of contact data, the system 100 may provide an identifier that allows one user to easily obtain another user's contact information. For example, the system 100 may generate an identifier, such as a QR code corresponding to a first user, so that a second user may obtain the first user's contact information. The system 100 may also generate other types of optical machine-readable codes to facilitate the exchange of contact information. The system 100 may also use other forms of “clickable” web-linked content. In some embodiments, the system 100 may also generate a series of letters, numbers, and other symbols that will act as clickable content that replaces phone numbers, email addresses, mailing addresses, and/or any kind of personally identifiable contact data. The first user may share these links as a form of contact data that a second user may click to communicate with the first user. These links may also be used to obtain a first user's contact information. In certain embodiments, other forms of personal identification may be used such as finger prints, eye scans, breathalyzer, etc. In other embodiments, devices may be used such as signals from smartphones, wearable devices, bodily-inserted-electronics, etc. In certain embodiments, the series of letters, numbers, and other symbols may be randomly generated or may be generated in accordance with rules so that the resulting series of letters, numbers, and other symbols conform to certain requirements. For example, the system 100 may employ rules that result in the series of letters, numbers, and other symbols being appropriate for pronunciation by the users so that exchange of contact information is further facilitated. In each of these cases, the identifier allows the system 100 to determine what contact data the new user may access. In some embodiments, this identifier may be used to create a new email account for use with just one contact, or the identifier may be generated as a phone number. In some embodiments, the user may define specific contact data to share depending on the contact device being employed. In some embodiments, users may transfer their personally identified code or image from one user to a second user so that newly added contact use the connection code that is linked to the transferring user and all past contacts already linked using the same connection code are given the contact data for the transferring user in all linked devices. Such an embodiment is particularly useful when a salesperson's contact list is to be transferred to a new salesperson. In some embodiments, the identifier may be used to access the user's calendar to schedule events. In other embodiments, the identifier shares specific personal and/or business, organizational, or sales data along with contact data to each user's device. In certain embodiments, each user may annotate their contact and share these annotations with other users selectively. In some embodiments, the identifier is used to connect to automated systems. the identifier may also include other information such as the creation time, a future date and/or time at which the identifier is no longer valid, and the like.

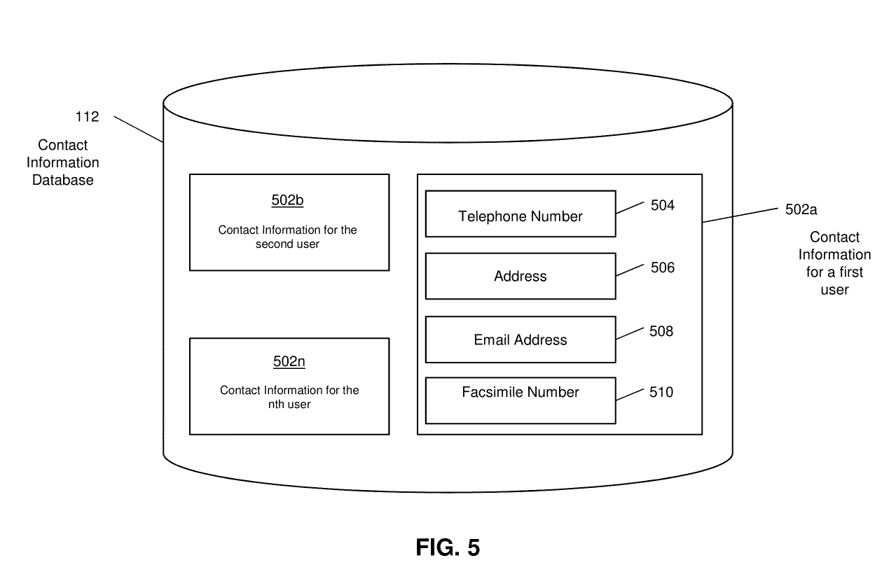

The current contact data saved in contact data packets with the user's contact data list of the first user device 104a is then uploaded and stored to the contact information database 112 in the processing server 110 via the network server 108. The contact information database 112 is illustrated in FIG. 5. As shown in FIG. 5, the contact information database 112 creates separate entries corresponding to a plurality of users. In FIG. 5, entries 502a, 502b . . . 502n correspond to the each of the plurality of user devices 104a-104n, as well as devices that are not connected to the system 100 such as those corresponding to the non-users. That is, the contact information database 112 creates separate entries for each of contact data entries stored on the first user device 104a. Each of the entries 502a, 502b . . . 502n includes separate fields for the contact information corresponding to the plurality of users and non-users. As shown in FIG. 5 for illustration purpose only, the entry 502a includes the contact information corresponding to the first user 102a and may include the first user's telephone number 504, an address 506, an electronic mail address 508, and/or a facsimile number 510. Of course, a person skilled in the art would recognize that additional fields or fewer fields for the contact information may be included for the entry 502a in the contact information database 112. Additional data may be stored with each contact, such as branding information, sales information, organizational information, and personal likes and dislikes—and including images, video, audio, and other non-text formats. Instant changes and updates to all data may be performed by the user by accessing the user's profile on their device, or accessing any other contact and changing their data, generating the “Request for Update” response communication to the appropriate user through communications means such as email, automated calls, SMS messaging, or other similar communication means.

Although examples of the information that may be stored in the fields have been depicted, it should be understood that the fields for each entry 502a may contain information in different forms including textual data, visual data, and other forms of information. Examples of information that are contained in these additional fields include personal preferences of the user 102a, relationship information, job information, and other information the user 102a would like to make available for other users of the system 100. Any changes to data may include a notification that a change has been made, such as an auditory tone, an animation, a video, an email, a text, etc. This information, when updated by the user 102a, is automatically propagated by the system 100 to the other devices (104b, 104c . . . 104n) so that other users (102b, 102c . . . 102n) so that when the other users (102b, 102c . . . 102n) access their respective devices (102b, 102c . . . 102n), the information for the user 102a is current.

In some embodiments, a user 102a may add personal business information to their contact data. This business information may include, for example, a listing of the products the user 102a is responsible for selling, branding information for the user 102a, hyperlinks to information being provided by the user 102a, or other types of information associated with the business information of the user 102a. In one exemplary example, the user 102a may modify his contact information to include a web link that allows other users to view the prices of the products being sold, coupons that are available, and current events and all data may be changed at any time and directly from the providing user's device. The other users can view this web link in addition to the other information contained in the contact data for the user 102a. This personal business information, like the other aspects of the contact data, are automatically propagated by the system 100 to the other devices (104b, 104c . . . 104n) so that other users (102b, 102c . . . 102n) can access the most current information for the user 102a.

In still further embodiments, certain aspects of the contact data for a user 102a may persist based on an association between an organization and the user 102a. As an illustrative example, the user 102a is an employee of a corporation. The user 102a may associate or integrate the corporation's business information with their contact data so that when the user 102a shares their contact data with another user, the user's 102a business information is automatically shared with the other user as well. In some embodiments, the business information from the corporation being associated or integrated with the contact data for the user 102a is set only by the corporation and cannot be modified by the user 102a and is updated instantly through the use of an administration device. In other embodiments, certain aspects of the business information from the corporation being associated or integrated with the contact data for the user 102a may be modified by the user 102a.

In another embodiment, the business information being associated with the contact data for the user 102a may be transferred to other users. For example, if user 102a is a salesperson, new contacts made during employment with the corporation by the user 102a may be stored by the system 100. The corporation may, using the system 100, transfer contacts from a first employee to a second employee, with that change instantly appearing in all previously linked devices, as well as connect all images and/or clickable links associated with that account to link new users to with the second employee's contact database. By employing the system 100, the corporation can ensure continuity of service for its customers because the new user will have the information necessary to maintain the corporation's relationships with the contacts made by the former user. In some embodiments, the contact information that is transferred to the new employee may include internal information such as group identifiers or internal contact lists, and other information useful to new employees or employees entering new roles. Group identifiers, if included with the internal information, may be used so that groups of employees, e.g., salespeople, may be identified.

Current contact Data of each user is collected. This data may be grouped together for the convenience of the users, so they can share those “data packets” through scan-able images and links, packets might be Social Data packets for when you meet people socially, Networking Packets for when you meet people for business, Corporate Data packets for companies, Sales Data packets for Trade Shows, etc. This current data is then either shared directly with other linked Users without traveling through an intermediary database, or it may be uploaded and shared through a central database. Each user may be responsible for his or her own data that is supplied to linked devices, or the community at large.

The processing server 110, in one exemplary embodiment, may be a cloud server remotely hosting the contact information database 112 on the web. The processing server 110 may share the contents of the contact information database 112 to a shared community that is accessible by all user devices 104a, 102b . . . 104n of the system 100, as well as devices that are not part of the system 100 such as non-user devices 105 corresponding to the non-users 103. In one exemplary embodiment, the shared community may be hosted on a website and accessible through a webpage 114 shown in FIG. 1, or may be a separate web entity that pulls data from within the system. The webpage 114 and its contents may be accessible by both user device 104 and non-user devices 105.

The processing server, in one exemplary embodiment, may act between two devices on a one to one basis, or act with a plurality of devices, to instantly update linked devices with updates to one's own contact data, to monitor databases for change and send update requests to the owners of that changed data, to instantly update linked devices with changes to any and all data, and to keep private and public notes for and on users.

The first user 102a may access the contact data entries corresponding to the contact data list stored on the first user device 104a, that is uploaded and stored on the contact information database and accessible via the webpage 114 from any internet enabled device including, but not limited to, the first user device 104a. The processing server 110 then sends an invitation to all contact data entries found within the first user's contact data list requesting the user devices corresponding to the contact data entries to join the system and to link with the first user device 104a. Invitations may be in the form of emails, automated, telephone calls, clickable links, machine-readable images, etc.

As the plurality of user devices 104b-104n join the system 100 and connect to the first device 104a using any form of contact data, physical features, digital devices, signals, etc., each of the plurality of user devices 104b-104n are provided access to the corresponding one of the entries 502b-502n. Once the users 102b-102n update the respective one of the entries 502b-502n using the respective user devices 104b-104n, the processing server 110 automatically updates the respective contact data entries of the contact data list stored on the first user device 104a.

Moreover, as the plurality of users devices 104b-104n join the system via the network server 108, the processing server 110 accesses the contact data list stored on each of the user devices 104b-104n and uploads and stores them on the contact information database 112 in the processing server 110 via the network server 108. That is, additional entries 502 corresponding to the additional contact data entries stored on the respective user devices 104b-104n are created in the contact information database 112. The processing server 110 then sends an invitation to all contact data entries found within the contact data lists stored on each of the user devices 104b-104n requesting the user devices corresponding to the contact data entries stored on each of the user devices 104b-104n to join the system and to link with the respective user device 104. As each user joins, the most current contact data for each user replaces the old contact data found in each linked device, thus ensuring all linked devices start out with 100% current data.

The system 100 further allows the first user 102a to alter the entries 502a-502n corresponding to the user devices 104b-104n that are linked to the first user device 104a on the system 100. The entries 502a-502n may be accessed using the first user device 104a and/or a plurality of other devices, including the publicly shared database displayed on the webpage 114.

The processing server 110 monitors the contact information corresponding to each of the users 102b-102n. Monitoring the contact information may include, but is not limited to, using the processing server 110 to monitor the contents of the plurality of user devices 104a, 104b . . . 104n, any cloud devices corresponding to the each of the users 102b-102n, the publicly shared database displayed on the webpage 114, and/or other public records via the network server 108. The public record may be one of Facebook®, LinkedIn®, Google Plus®, or any number of other such publicly available information as understood by a person skilled in the art.

When one of the user devices 104b-104n changes the contact information corresponding to the first user device 104a within the contact data list stored on the one user device, the processing server 110 transmits a verification message to the first user device 104a seeking confirmation of the accuracy of the changed contact information. When the processing server 110 receives confirmation from the first user device 104a indicating that the changed contact information is accurate, the processing server 110 updates all the user devices that are linked to the first user device 104a with the changed contact information corresponding to the first user device 104a. That is, the processing server 110 updates the contact data entry within the contact data list stored on each of the user devices linked to the first user device 104a.

Moreover, the processing server 110 also updates the entry 502a stored in the contact information database and makes the changed contact information corresponding to the first user 102a publicly available via the webpage 114. If the first user 102a changes their own contact information within the first user device 104a or the entry 502a in the contact information database 112, the processing server 110 automatically and instantly updates the plurality of user devices 104b-104n linked to the first user device 104a via the network server 108.

Although the above embodiments are described in a manner where all of the information in a user device 104a, 104b, 104c . . . 104n is transferred to the processing server 110, certain embodiments of may allow for only designated portions of the information in the user devices 104a, 104b, 104c . . . 104n to be transferred to the processing server 110. For example, if user 102a identified at least one aspect of the contact information contained in the first user device 104a that should not be transferred, the designated aspect will not be transferred to the processing server 110. The designated aspect of the contact information may correspond to an entire entry 502a, 502b, 502c . . . 502n, or the designated aspect of the contact information may correspond to a field of an entry, such as a contact's electronic mail address 508.

In some embodiments where business information is included with the contact data, a user 102a may add business information so that upon entry, the information is propagated to the other users 102b, 102c . . . 102n which share the business information. For example, if the user 102a obtains the contact data for a new customer, the user 102a may enter this information into their device that is associated with the system 100. The new customer's contact information is then propagated by the system 100 to other users 102b, 102c . . . 102n that share business information so that all of the users 102a, 102b, 102c . . . 102n can simultaneously, including a business' host platform system, may use the most recent contact information.

When the first user device 104a changes the contact information corresponding to one of the other user devices 104b-104n within the contact data list stored on the first user device, the processing server 110 transmits a verification message to the one other user device 104 seeking confirmation of the accuracy of the changed contact information. When the processing server 110 receives confirmation from the one other user device 104 indicating that the changed contact information is accurate, the processing server 110 updates all the user devices that are linked to the one other user device 104 with the changed contact information. That is, the processing server 110 updates the contact data entry within the contact data list stored on each of the user devices linked to the one other user device 104. Moreover, the processing server 110 also updates the entry 502 stored in the contact information database corresponding to the one other user device 104 and makes the changed contact information corresponding to the one other user device 104 publicly available via the webpage 114. A notification that data has changed within the system may or may not occur.

If an entry 502 on the contact information database 112 corresponding to any non-user 103 is changed, then all user devices 104 linked to that entry 502 on the contact information database 112 corresponding to that non-user 103 are updated with that change. If the non-user 103 subsequently claims ownership of the entry 502 on the contact information database 112 corresponding to that non-user 103, the non-user 103 may prevent others from editing the corresponding entry 502 on the contact information database 112 by locking the entry. Therefore, the system 100 allows the users connected to the system to control the changes made to their respective entries 502 on the contact information database 112.

This system may be provided as an overlay on top of existing business contact data platforms. The system would link existing contact accounts through the various invitation systems, allow the plurality of contacts to join and link to the system, providing the company with each user's most current contact data, and give each user control of the quantity and kind of data shared with the business entity.

Businesses may format their contact data into a “Welcoming System” or “Onboarding System” that is displayed within each user's device. This displayed data may be changed using the crowd sourcing system described herein, and all employee links may be displayed in a group by department. This visual contact page could feature music, images and video, business data, and even links to internal organization ERP system functions, such as inventory, production, services, statistics, testimonials, etc.

The system 100 thus provides improved management of a database storing contact information that reduces the need for human input of information, reduces electronic communications and updating, and reconciliation of multiple databases in a computationally less intense manner. Additional advantageous aspects of the present disclosure are explained below.

The system 100 may assign a permanent video chat room for each user 102a-102n that joins the system. Within each video chat room, user devices 104a-104n may be provided access to the following non-exhaustive list of features including: (i) the crowd sourced contact information database 112 storing the contact information for each of the user devices 104a, 104b . . . 104n; (ii) a merchant contact database explained later; (iii) an entire suite of point-and-click contact systems discussed in greater detail below; (iv) point of sale system discussed in greater detail below; (v) search engine explained later; (vi) shared calendar explained in greater detail below; (vii) social network based personal testimonial marketing system; and/or (viii) brand tracking and building system.

With the advent of the smartphone, many people have stopped memorizing phone numbers. Instead, they scroll through their contact list on their device, pick the name they want to communicate with and choose the form of communication they wish to use (for instance, text, email, telephone call, or the like) thereby removing the need to remember the specific contact information. In one advantageous aspect of the present application, the system 100 allows a user 102 to use randomly generated letters, numbers, and symbols as their contact information. Such randomly generated contact information may be provided to an outside party, such as a telemarketer. Subsequently, if the contact information is abused by the outside party, the user 102 may delete or modify the number so that the user 102 can no longer be contacted by the outside party. The user's 102 other contacts are not, however, affected by this change in contact information because only the outside party was aware of the randomly generated contact information. This advantageous aspect is applicable in situations where the outside party harasses the user 102 with frequent calls or when the outside party monetizes the user's 102 contact information by selling the information to a third party, for example.

Another advantageous aspect of the application allows the user 102a to remove the outside party from their contact data list stored on the first user device 104a, and subsequently change their contact information. The changed contact information is automatically transmitted to the plurality of users 104b-104n linked to the first user device 104a via the processing server 110 leaving outside party without access to the changed contact information corresponding to the first user device 104a.

In another advantageous aspect of the present embodiment, employers may use the system 100 to automatically update contact database based on updates in employee smartphone contact lists. Thus, the employee contact database is maintained with accurate information.

Next, the merchant contact database discussed above will be explained. A crowd sourced/shared “local-zip-code” to “Global-Market” merchant contact database may be made available within the video chat room assigned to each user. This system 100 is designed to allow the users 104 of the system keep all data on businesses current. Users 104 can filter out entries 502 on the contact information database 112 corresponding to failed businesses, add new entries 502 on the contact information database 112 corresponding to new businesses, or provide feedback to, and on, local businesses. Any changes in the contact information corresponding to the merchants 106 are then automatically shared with the user devices 104 connected to the contact information database 112.

Merchants may then subsequently claim ownership of the entry 502 on the contact information database 112 corresponding to their contact information. The merchants 106 may then add their own advertising in real-time to the contact information database entry 502 to influence buyer decisions thereby creating a new online Point of Purchase system. In an embodiment, the advertising may be targeted only at specific areas of business operations (i.e., local to global).

For instance, when user 102a enters a new merchant 106a's contact information into the system, all users within user 102a's zip code may instantly be provided access to contact information corresponding to the merchant 106a. All users in that postal code may now user their full communication systems (described below) provided in the video chat room to contact the merchant 106a. Moreover, user 102a may provide shared information relating to the merchant 106a such as product reviews, notes on maps for directions, tips, best times to call, best people to talk to, etc. which is made available to other users within the system 100 that are linked to the user device 104a corresponding to the user 102a.

As described earlier, merchant 106a may claim the entry 502 on the contact information database 112 corresponding to their contact information by joining the system 100. Once the merchant 106a claims ownership of the entry 502 on the contact information database 112 corresponding to their contact information, other users may be prevented from changing the merchant 106a's contact information. The merchant 106a may list all active business areas by zip code. A contact information database for each of those zip codes may be generated which may be made accessible to all users within those zip codes. Moreover, merchant 106a may list all products under generic headings such as Electronics, Hardware, Apparel, Food etc.

In one embodiment, the system 100 may allow merchant 106a to change their business logo into a banner ad that displays online specials in an attempt to sway online buyers to purchase their products. Users may directly access merchant 106's order system through a Point of Service System provided within the system 100. Users may directly choose desired products online, purchase the products, and then have the products delivered or drive out and pick them up.

An example using a Pizza Shop is provided for the purpose of illustration. A user 102a may search for “Food” within the system 100 using their individual video chat room, look under a tab labeled “Restaurants” and subsequently filter out merchants that provide delivery service. The user 102a might see five delivery restaurants operating in their area. The user 102a may choose to review the different banner ads offering specials. For instance, the user 102a chooses a merchant 106b offering an offer. The user 102a may then choose merchant 106b, review their contact information, review their delivery map to confirm they are within merchant 106b's delivery area, and make a purchase through the system 100. In one embodiment, the user 102a is directed to merchant 106b's Point of Service system where the user 102a may order the desired products and complete the transaction. The user 102a may then fill out a review of merchant 106b's food, which is instantly shared with all users within merchant 106b's operating areas based on the zip codes merchant 106b has provided as operating areas.

Continuing the Pizza Shop example, in another embodiment, the user 102a may choose the merchant 106b, review their contact information, and then decide to make an in-person purchase of pizza. After the user 102a has arrived at the Pizza Shop, the user may be presented with a link to the Pizza Shop. By selecting the link, the system 100 transmits the contact information for the merchant 106b to the user device 104a. In certain embodiments, selection of the link may transmit the contact information for a salesperson for the merchant 106b to the user device 104a. Other embodiments may transmit additional types of information in response to the selection by the user 102a, but are not specifically enumerated here.

The individual video chat room assigned to each user 102 connected to the system 100 may include an entire suite of point-and-click contact systems, such as, but not limited to, email, text, video chat, video mail, and VoIP telephony systems, as well as social systems connection like Facebook® and LinkedIn® access. The video chat room may be designed to allow users to add another user to an ongoing conversation with other users. The system 100 may allow users to see if other intended contacts are available to be contacted or are busy. The system 100 may also allow users to be invisible to other users on the system 100 while they browse the system 100. The system 100 may be designed to operate as a communications umbrella where each merchant 106 may be provided with their own permanent video chat room. Employees of the merchant 106 may use the system 100 to contact other employees within the merchant network or with other users.

The system 100 may also provide merchants 106 with their own online to local Point of Sale system where users may be able to access the same ordering system either online or in the store to buy desired products. The system 100 may use credit/debit payment systems to pay for products either online or in person at the store.

The system 100 may include a search engine in some embodiments. This search engine may begin with a complete list of all products that are for sale which may be categorized based on product categories—for example, “Electronics” or “Furniture.” Merchants 106 may list themselves under each product category. Users 102 may then access the system 100 and may either search by generic product, by generic product heading, or by a directory. The user may select the generic product such as, for instance, an image and description of 60″ plasma, 1080P high definition, flat screen television—or a generic heading, such as “plasma, high definition, flat screen television,” and obtain a form requesting the user to add specific details related to the purchase. For instance, the request may include details such as cost, delivery time, or technical specification. The user may then request a quote from merchants 106 that are connected to the system and that have signed up to receive communication relating to the specific generic product.

This quote may include the user's desired specifications for the product and their most recent contact information. The merchant 106 upon receiving the quote may respond back to the user with their best offer. The user may then select the best offer, and may purchase the product using the payment system found within the system 100 described above or through a link to a third party like a bank, PayPal®, or other payment system. Additionally, the system 100 may include a section highlighting new products. Using the television example discussed above, the user may search for televisions generally, and may receive a link for new televisions available along with the complete product listings.

The system 100 may also include a shared calendar in which all user devices 104b-104n connected with the user device 104a are provided access and editing rights to a common calendar. In addition, each user 102 may be given the ability to post videos and images into their respective entry 502 that may be made accessible to the user devices 104 that are connected to the user device sharing the videos and images.

The system 100 may provide a social network based personal testimonial marketing feature. The system 100 may involve merchants offering users a discount on a purchase in exchange for the user answering a customer survey. The system 100 may allow the user to post the customer survey answers quickly and easily on a social network site such as Facebook® or the like. Moreover, the system 100 may access social networks through the user's smartphone apps, provide a form for the user to fill out providing feedback, share the form including the feedback publicly, and subsequently apply the discount to the user's purchase order.

In one embodiment, the system 100 may include a brand tracking and building feature. The system 100 may allow merchants 106 to track users who purchase their products. For instance, all users in a merchant 106's area of operation (based on, for instance, zip codes provided by the merchant 106) are considered to be that merchant 106's total universe of users. The system 100 may then track each user as they access products within the system. The system may categorize a user as a “Potential Customer” if that user enters a particular merchant's topic of products. For instance, merchant 106a may sell “Fertilizer” and user enters the heading “Gardening” within the search engine. The system 100 may categorize the user to “Aware but no purchase” if the user enters the topic “Fertilizer” where the merchant 106a is listed. The user may be provided access to merchant 106a's point of purchase banner ad.

The system 100 may categorize the user as a potential “Lead” if the user selects merchant 106's banner ad, but does not purchase the product. The system 100 may categorize the user as a “Customer” if the user purchases the product from the merchant 106a. The system 100 may categorize the user as a “Repeat Customer” if the user makes a subsequent purchase with merchant 106. The system 100 may then offer the user a chance to earn an instant discount on the third purchase from merchant 106a if the user will fill out an “instant testimonial” form (supplied by the system 100) that will be posted to that user's social network (e.g., Facebook®).

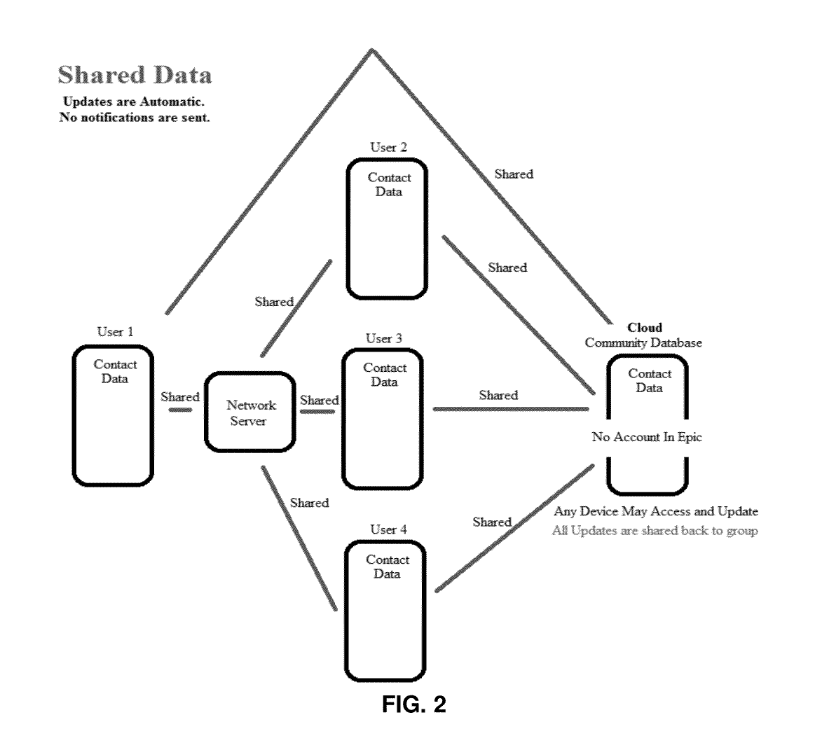

FIG. 2 shows a high level architecture and data flow diagram illustrating the system for managing contact information of a plurality of users in accordance with exemplary embodiments. A plurality of user devices share their respective contact data list with other connected user devices where any update in the contact information corresponding to one of the user devices is shared automatically and instantly with the other connected user devices. Moreover, a shared cloud-based community database may be provided which may be accessible by any of the user devices. Any updates to the shared cloud-based community database are automatically and instantly shared with the connected user devices.

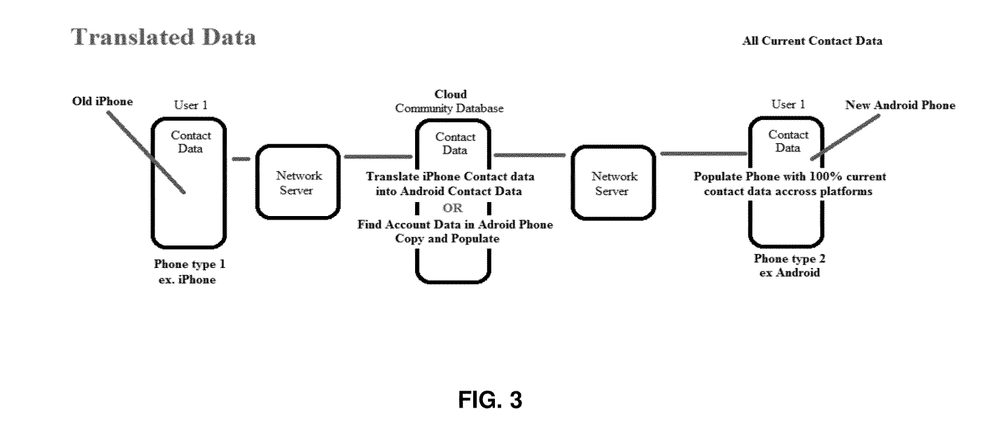

FIG. 3 illustrates another advantageous aspect of the system 100 disclosed in the present application. Specifically, because the contact data list for one user device 104a is stored on the contact information database 112 and may be accessed via a plurality of user devices connected with the first user 102, the system provides cross-platform accessibility. In the example illustrated in FIG. 3, a contact data list stored on an Apple iPhone® is uploaded and stored on the shared cloud-based community database via the network server 108. The user may then download the contact data list stored on the shared cloud-based community database using a user device which has an Android® platform via the network server 108.

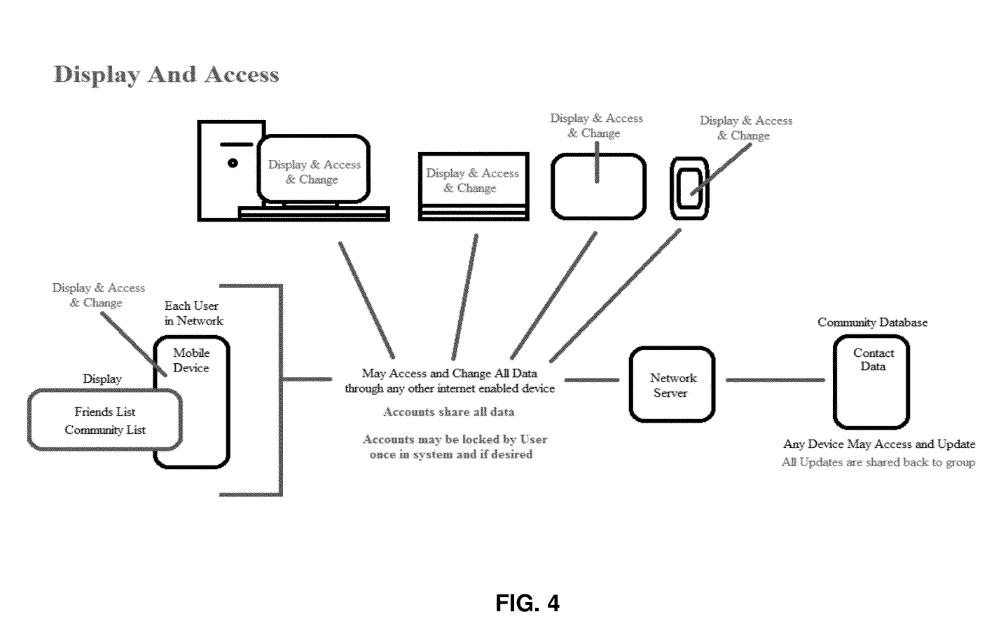

FIG. 4 illustrates a plurality of user devices 104 which may be used to access the contact information database 112. For instance, FIG. 4 shows, by way of examples only, a cellular phone, smart phone, tablet computer, PDA, and desktop computer which may be used to access the contact information.

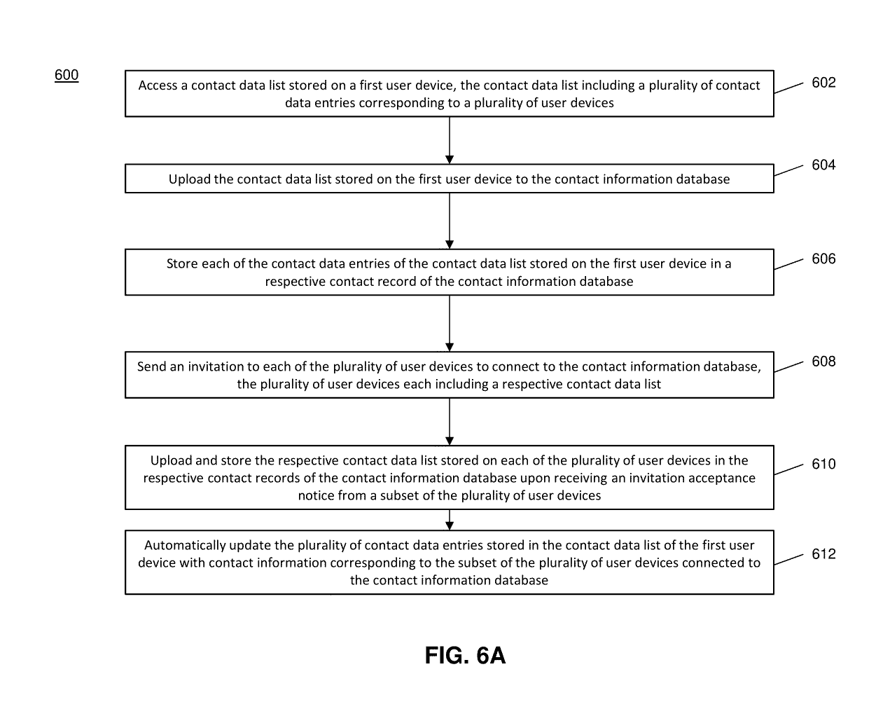

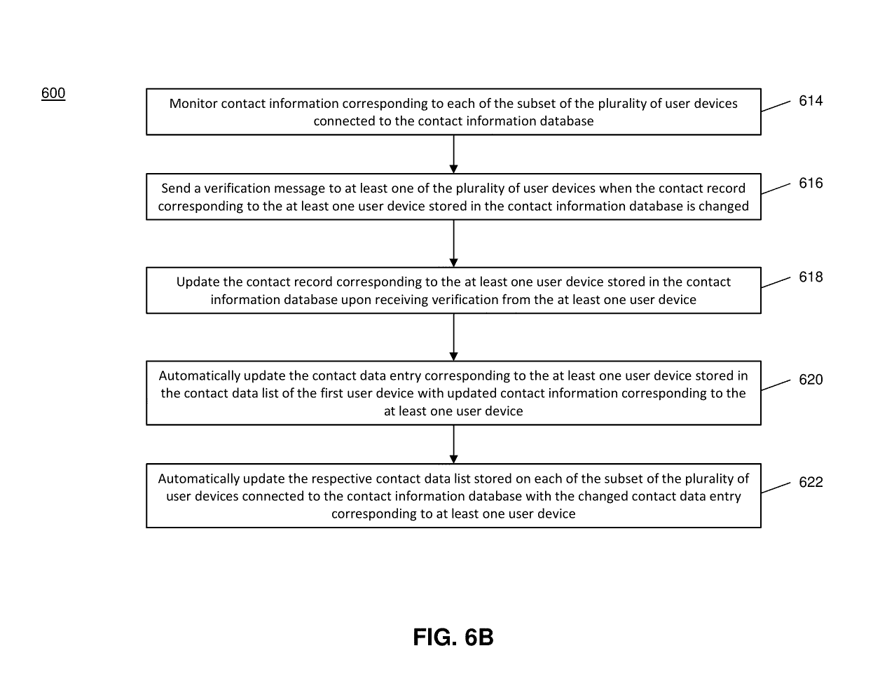

FIGS. 6A and 6B show a flowchart illustrating the method of operation of the system discussed above. At step 602, the contact data list of a first user in a first device is accessed. At step 604, the first user's contact database is uploaded and stored in a contact information database. At step 606, the uploaded contact data is posted to a shared community that is accessible by all users. At step 608, invitations are sent to all contacts found within the first user's contact database requesting a plurality of other user devices to connect with the first user device.

At step 610, as the plurality of users join their updated contact information is then used to update the first user's contact database. The first user is allowed to change data of any account within the first device, and/or a plurality of other devices, including the public shared database. At step 614, the processing server 110 monitors the contact information corresponding to each of the other user devices, the shared public records, and/or other public records. At step 616, a verification message is sent to the first user device if a second user changes the first user's contact data. Following receipt of confirmation at step 618, the processing server 110 updates all linked devices when the contact information corresponding to at least one other user device is changed. At step 620, the changed contact information corresponding to the first user device is automatically transmitted to the plurality of other user devices connected to the network server.

If the first user changes their personal contact information, the method includes automatically and instantly updating the plurality of users connected to the first user's database with that changed contact information. If the first user changes contact data of a second user in the first user's device, the method includes automatically generates and sends an email to the second user asking if the second user has changed their contact data—allowing the second user to update their contact data within that email—which then updates all devices and public records connected to the second user's database—which updates the first user's contact record of the second user. If any user or non-user changes data to a non-account contact data, then all contacts linked to that non-account/public record are updated with that change. If a non-account record is claimed by a user, then that user may choose to lock their record so that only they may change that record.

Although the above described embodiments of the method and system for crowd sourced contact database management is described in the context of an independent system, the method and system may also be employed in conjunction with existing contact management systems. In one embodiment, the system 100 for crowd sourced contact database management interfaces with a company's existing contact management system so that non-users may employ an identifier to connect with the system 100. As described above, the identifier may be a QR code, another type of optical machine-readable codes, or a sequence of letters, numbers, and other symbols. Once this identifier is provided, the system 100 may then transfer relevant contact data from the company's existing contact management system to the new user's device. Other aspects of the system 100 for crowd sourced contact database management, including the ability for the owner of the contact data to confirm any updates to contact information that is modified by either new or existing users, will continue to operate while the system 100 is operating in conjunction with existing contact management systems. By employing the method and system for crowd sourced contact data management in conjunction with a company's existing contact management system, users that are not already connected with the company's existing contact management system can benefit from the corpus of existing contact data contained in the company's existing contact management system and from the features provided by the method and system described here.

### Computer System Architecture

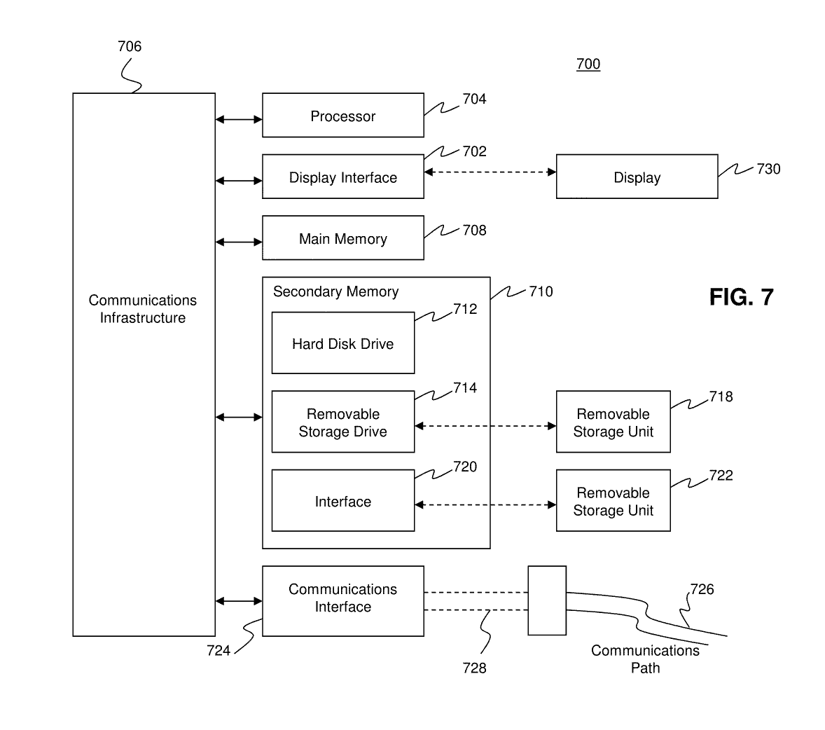

FIG. 7 illustrates a computer system 700 in which embodiments of the present disclosure, or portions thereof, may be implemented as computer-readable code. For example, the processing server 110 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6A and 6B.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network, multi-core message-passing scheme, etc. The network may be any network suitable for performing the functions as disclosed herein and may include a local area network (LAN), a wide area network (WAN), a wireless network (e.g., Wi-Fi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods and systems, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems, and methods for analyzing spending data for online transactions. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for managing contact information of a plurality of users comprising:
accessing, by a processing device, a contact data list stored on a first user device, the contact data list including a plurality of contact data entries corresponding to a plurality of user devices;
uploading, by the processing device, the contact data list stored on the first user device to a contact information database, the contact information database having a plurality of contact records corresponding to each of the plurality of users;
storing, by the processing device, each of the contact data entries of the contact data list stored on the first user device in a respective contact record of the contact information database;
sending, by the processing device, an invitation to each of the plurality of user devices to connect to the contact information database, the plurality of user devices each including a respective contact data list;
uploading and storing, by the processing device, the respective contact data list stored on each of the plurality of user devices in the respective contact records of the contact information database upon receiving an invitation acceptance notice from a subset of the plurality of user devices;
automatically updating, by the processing device, the plurality of contact data entries stored in the contact data list of the first user device with contact information corresponding to the subset of the plurality of user devices connected to the contact information database;
monitoring, by the processing device, contact information corresponding to each of the subset of the plurality of user devices connected to the contact information database;
sending, by the processing device, a verification message to at least one of the plurality of user devices when the contact record corresponding to the at least one user device stored in the contact information database is changed;
updating, by the processing device, the contact record corresponding to the at least one user device stored in the contact information database upon receiving verification from the at least one user device;
automatically updating, by the processing device, the contact data entry corresponding to the at least one user device stored in the contact data list of the first user device with updated contact information corresponding to the at least one user device; and
automatically updating, by the processing device, the respective contact data list stored on each of the subset of the plurality of user devices connected to the contact information database with the changed contact data entry corresponding to at least one user device.

2. The method according to claim 1, further comprising:
automatically updating, by the processing device, the respective contact data list stored on each of the subset of the plurality of user devices connected to the contact information database when a contact record in the contact information database corresponding to a user device not connected to the contact information database is changed.

3. The method according to claim 1, further comprising:
allowing at least one user device not originally connected to the contact information database to subsequently connect to the contact information database; and
preventing other user devices from changing the contact record in the contact information database corresponding to the at least one user device not originally connected to the contact information database.

4. The method of claim 1, further comprising:
sending, by the processing device, an invitation to a plurality of additional user devices stored in the respective contact data list of the subset of the plurality of user devices to connect to the contact information database.

5. The method of claim 1, further comprising:
assigning each of the first user devices and the plurality of user devices a respective chat room;
each of the chat room including the plurality of contact records stored on the contact information database corresponding to the respective contact data list stored on the plurality of user devices; and
providing a communication system within each of the respective chat rooms to connect with the plurality of user devices.

6. The method of claim 1, further comprising:
assigning the first user device temporary contact information;
transmitting a request to a merchant device to connect with the first user device, the request including the temporary contact information; and
connecting to the merchant device.

7. The method of claim 6, further comprising:
sending a request, by the processing device, to the merchant device for an offer directed to a product;
receiving the offer from the merchant device directed to the product;
purchasing the product; and
deleting the temporary contact information after purchase is completed.

8. The method of claim 7, further comprising:
transmitting a survey by the merchant device to be completed by the first user device;
transmitting the completed survey to the merchant device; and
transmitting the completed survey to the plurality of other user devices connected to the contact information database.

9. The method of claim 8, wherein the merchant device transmits a reward to the first user device upon completion of the survey.

10. The method of claim 1, wherein each of the user devices are assigned unique QR codes, and the contact data list in the first user device is updated by scanning each of the QR codes.

11. A system for managing a contact information database for a plurality of users comprising:
a contact information database including a plurality of contact records corresponding to each of the plurality of users;
a processing device configured to:
access a contact data list stored on a first user device, the contact data list including a plurality of contact data entries corresponding to a plurality of user devices;
upload the contact data list stored on the first user device to the contact information database;
store each of the contact data entries of the contact data list stored on the first user device in a respective contact record of the contact information database;
send an invitation to each of the plurality of user devices to connect to the contact information database, the plurality of user devices each including a respective contact data list;
upload and store the respective contact data list stored on each of the plurality of user devices in the respective contact records of the contact information database upon receiving an invitation acceptance notice from a subset of the plurality of user devices;
automatically update the plurality of contact data entries stored in the contact data list of the first user device with contact information corresponding to the subset of the plurality of user devices connected to the contact information database;
monitor contact information corresponding to each of the subset of the plurality of user devices connected to the contact information database;
send a verification message to at least one of the plurality of user devices when the contact record corresponding to the at least one user device stored in the contact information database is changed;
update the contact record corresponding to the at least one user device stored in the contact information database upon receiving verification from the at least one user device;
automatically update the contact data entry corresponding to the at least one user device stored in the contact data list of the first user device with updated contact information corresponding to the at least one user device; and
automatically update the respective contact data list stored on each of the subset of the plurality of user devices connected to the contact information database with the changed contact data entry corresponding to at least one user device.

12. The system according to claim 11, wherein the processing device being further configured to
automatically update the respective contact data list stored on each of the subset of the plurality of user devices connected to the contact information database when a contact record in the contact information database corresponding to a user device not connected to the contact information database is changed.

13. The system according to claim 11, wherein the processing device is further configured to:
allow at least one user device not originally connected to the contact information database to subsequently connect to the contact information database; and
prevent other user devices from changing the contact record in the contact information database corresponding to the at least one user device not originally connected to the contact information database.

14. The system of claim 11, wherein the processing device is further configured to:
send an invitation to a plurality of additional user devices stored in the respective contact data list of the subset of the plurality of user devices to connect to the contact information database.

15. The system of claim 11, wherein the processing device is further configured to:
assign each of the first user devices and the plurality of user devices a respective chat room;
each of the chat room including the plurality of contact records stored on the contact information database corresponding to the respective contact data list stored on the plurality of user devices; and
provide a communication system within each of the respective chat rooms to connect with the plurality of user devices.

16. The system of claim 11, wherein the processing device is further configured to:
assign the first user device temporary contact information;
transmit a request to a merchant device to connect with the first user device, the request including the temporary contact information; and
connect to the merchant device.

17. The system of claim 16, wherein the processing device is further configured to:
send a request to the merchant device for an offer directed to a product;
receive the offer from the merchant device directed to the product;
purchase the product; and
delete the temporary contact information after purchase is completed.

18. The system of claim 17, wherein the processing device is further configured to:
transmit a survey by the merchant device to be completed by the first user device;
transmit the completed survey to the merchant device; and
transmit the completed survey to the plurality of other user devices connected to the contact information database.

19. The system of claim 18, wherein the merchant device transmits a reward to the first user device upon completion of the survey.

20. The system of claim 11, wherein each of the plurality of user devices are assigned unique QR codes, and the contact data list in the first user device is updated by scanning each of the QR codes assigned to the plurality of user devices.
